(19) United States
(12) Patent Application Publication
(10) Pub. No.: US 2026/0192574 A1
(43) Pub. Date: Jul. 9, 2026

(54) PRINTING DEVICE

(71) Applicant: SEIKO EPSON CORPORATION, Tokyo (JP)

(72) Inventors: Akimasa NOZAWA, TATSUNO-MACHI (JP); Junki AKAMA, NAGANO-SHI (JP); Yoichi KOBAYASHI, MATSUMOTO-SHI (JP); Shinichi ISHIDA, MATSUMOTO-SHI (JP); Yuta MIYAMA, MATSUMOTO-SHI (JP)

(21) Appl. No.: 19/442,373

(22) Filed: Jan. 7, 2026

(30) Foreign Application Priority Data
Jan. 9, 2025 (JP) 2025-003631

(51) Int. Cl. B41J 3/46; B41J 11/00; B41J 11/08; B41J 15/04; B41J 25/00; B41J 29/13

(52) U.S. Cl. CPC B41J 3/46; B41J 11/002; B41J 11/08; B41J 15/04; B41J 25/005; B41J 29/13

(57) ABSTRACT

A printing device includes: a head that ejects a liquid onto a medium; a conveyance unit that conveys the medium in a conveyance direction; a carriage that holds the head and can scan the medium with the head in a scanning direction; a platen that supports the medium at a position where the medium can face the head; a housing that accommodates the carriage; a medium support unit that is provided so as to protrude downstream in the conveyance direction from the housing and supports the medium conveyed in the conveyance direction from the platen, at a support surface; and an operation unit used for various operations, in which the medium support unit includes a heating unit that heats the medium from the support surface side, and the operation unit is provided at a side surface downstream in the conveyance direction, of the housing.

The present application is based on, and claims priority from JP Application Ser. No. 2025-003631, filed Jan. 9, 2025, the disclosure of which is hereby incorporated by reference herein in its entirety.

### BACKGROUND

### 1. Technical Field

The present disclosure relates to a printing device.

### 2. Related Art

According to the related art, various printing devices are used. These printing devices include a printing device having an operation unit used for various operations and a medium support unit that supports a conveyed medium. For example, JP-A-2013-240985 discloses a recording device having an operation panel used for various operations, and a discharge support unit serving as a medium support unit that includes a heating unit and supports a conveyed recording medium.

JP-A-2013-240985 is an example of the related art.

The recording device disclosed in JP-A-2013-240985 has a configuration in which a discharge support unit is disposed at a position protruding toward a side where an operator is located when operating the operation panel (operator side). As described above, in the configuration in which the medium support unit having the heating unit and protruding to the operator side is disposed, when the operator operates the operation unit, the operation may be obstructed by the medium support unit heated by the heating unit, or the like, and it may be difficult to operate the operation unit.

### SUMMARY

According to an aspect of the present disclosure, a printing device includes: a head that ejects a liquid onto a medium; a conveyance unit that conveys the medium in a conveyance direction; a carriage that holds the head and can scan the medium with the head in a scanning direction intersecting the conveyance direction; a platen that supports the medium at a position where the medium can face the head; a housing that accommodates the carriage; a medium support unit that is provided so as to protrude downstream in the conveyance direction from the housing and supports the medium conveyed in the conveyance direction from the platen, at a support surface; and an operation unit used for various operations, in which the medium support unit includes a heating unit that heats the medium from the support surface side, and the operation unit is provided at a side surface downstream in the conveyance direction, of the housing.

### BRIEF DESCRIPTION OF THE DRAWINGS

FIG. 1 is a schematic side view of a printing device according to an embodiment of the present disclosure.

FIG. 2 is a perspective view of the printing device in FIG. 1.

FIG. 3 is a side view of the periphery of an operation unit of the printing device in FIG. 1, showing a state where a maintenance cover is closed.

FIG. 4 is a perspective view of the periphery of the operation unit of the printing device in FIG. 1, showing the state where the maintenance cover is closed.

FIG. 5 is a perspective view of the periphery of the operation unit of the printing device in FIG. 1, showing a state where the maintenance cover is opened.

FIG. 6 is a side view of the periphery of an operation unit of a printing device according to a reference example, showing a state where a maintenance cover is closed.

FIG. 7 is a perspective view of the periphery of the operation unit of the printing device in FIG. 6, showing the state where the maintenance cover is closed.

### DESCRIPTION OF EMBODIMENTS

First, an overview of the present disclosure will be given.

According to a first aspect of the present disclosure, a printing device includes: a head that ejects a liquid onto a medium; a conveyance unit that conveys the medium in a conveyance direction; a carriage that holds the head and can scan the medium with the head in a scanning direction intersecting the conveyance direction; a platen that supports the medium at a position where the medium can face the head; a housing that accommodates the carriage; a medium support unit that is provided so as to protrude downstream in the conveyance direction from the housing and supports the medium conveyed in the conveyance direction from the platen, at a support surface; and an operation unit used for various operations, in which the medium support unit includes a heating unit that heats the medium from the support surface side, and the operation unit is provided at a side surface downstream in the conveyance direction, of the housing.

According to this aspect, the operation unit is provided at the side surface downstream in the conveyance direction, of the housing. With such a configuration, when the operator operates the operation unit, the operation unit is closer to the operator than an upper part of the housing. Therefore, the operator can be spaced apart from the medium support unit, and the chance of coming into contact with the heated medium support unit is reduced. Thus, in a configuration in which the medium support unit having the heating unit and protruding to the operator side is disposed, the operator can easily operate the operation unit.

According to a second aspect of the present disclosure, in the printing device according to the first aspect, the operation unit is located on one side in the scanning direction in relation to the medium support unit.

According to this aspect, the operation unit is located on one side in the scanning direction in relation to the medium support unit. With such a configuration, even when operating with one hand, the operator can easily operate the operation unit at a position where the body of the operator is spaced apart from the medium support unit.

According to a third aspect of the present disclosure, the printing device according to the second aspect further includes a maintenance unit that is located on the one side in relation to the platen in the housing and can face the head, and the housing includes a maintenance cover that can open an upper side of the maintenance unit.

According to this aspect, since the maintenance unit is provided, the head can continue to be used suitably. Also, the housing has the maintenance cover that can open the upper side of the maintenance unit. Since the operation unit is located on the side surface, with such a configuration, the upper surface of the housing can be widely opened and workability can be improved.

According to a fourth aspect of the present disclosure, in the printing device according to the third aspect, an upper surface is flat when the maintenance cover is in a closed state.

According to this aspect, the upper surface is flat when the maintenance cover is in the closed state. With such a configuration, a PC, a document, or the like can be placed on the flat surface, and the operator can perform work using the PC or check the document or the like while operating the operation unit.

According to a fifth aspect of the present disclosure, in the printing device according to the fourth aspect, an upper end of the operation unit is located below the upper surface, and the maintenance cover can open a space between the upper end and the upper surface.

According to this aspect, the maintenance cover can open the space between the upper end of the operation unit and the upper surface of the housing. With such a configuration, since not only the upper surface of the maintenance cover but also at least a part of the side surface of the maintenance cover can be opened, workability is particularly improved.

According to a sixth aspect of the present disclosure, in the printing device according to any one of the first to fifth aspects, the operation unit includes a display unit.

According to this aspect, the operation unit includes the display unit. With such a configuration, the operator can perform an operation while checking information displayed on the display unit.

According to a seventh aspect of the present disclosure, in the printing device according to the sixth aspect, the display unit also serves as an input unit.

According to this aspect, the display unit also serves as the input unit. That is, for example, the operation unit can be a touch panel. By using a touch panel as the operation unit, the operator can input various instructions while checking information displayed on the display unit even when there is only a small space on the side surface of the housing or the maintenance cover.

According to an eighth aspect of the present disclosure, in the printing device according to any one of the first to seventh aspects, the operation unit includes a displacement mechanism that enables a displacement between a state where at least a part of the operation unit protrudes from the housing and a state where the operation unit is accommodated in the housing.

According to this aspect, the operation unit includes the displacement mechanism that enables a displacement between the state where at least a part of the operation unit protrudes from the housing and the state where the operation unit is accommodated in the housing. With such a configuration, since the operation unit can be accommodated in the housing when the operation unit is not operated, the operation unit can be prevented from becoming an obstacle during work around the printing device other than work of operating the operation unit.

According to a ninth aspect of the present disclosure, in the printing device according to the eighth aspect, the displacement mechanism is a tilt mechanism.

According to this aspect, the displacement mechanism is a tilt mechanism. With such a configuration, the operator can freely change the posture of the operation unit, and the operator can operate the operation unit in a posture that enables the operator to easily operate the operation unit.

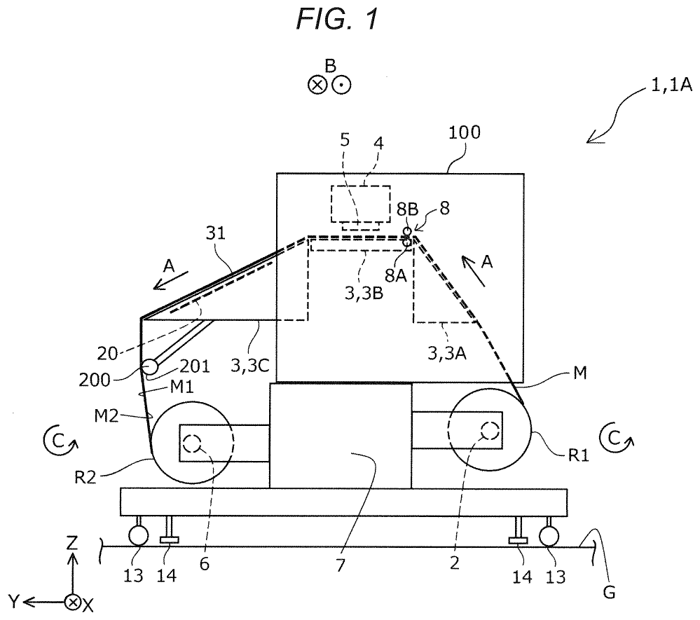

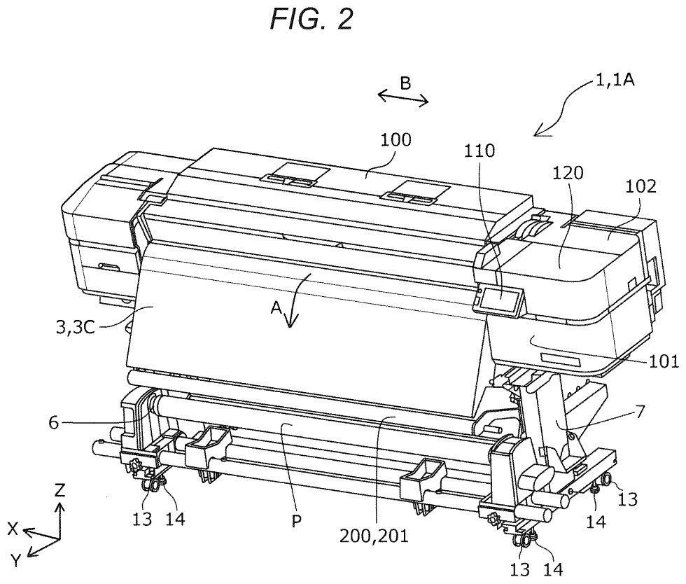

Hereinafter, an embodiment according to the present disclosure will be specifically explained with reference to the drawings. First, an outline of a printing device 1A according to an embodiment of a printing device 1 of the present disclosure will be described with reference to FIGS. 1 and 2. In FIG. 1, some component members are simplified or omitted in order to facilitate the understanding of the configuration. In each drawing, an X-axis direction in the illustration is a horizontal direction and is an axial direction of a roll body R1 formed of a medium M wound in a roll shape, a Y-axis direction is a horizontal direction and is a front-rear direction of the printing device 1A, and a direction orthogonal to the X-axis direction, and a Z-axis direction is a vertical direction. It is assumed in the following description that the side at which an arrow points corresponds to a positive (+) direction, and that the side opposite the side at which the arrow points corresponds to a negative (−) direction. For example, the vertically upward direction is a +Z direction, the vertically downward direction is a −Z direction, the front of the printing device 1A is a +Y direction, and the rear of the printing device 1A is a −Y direction.

As illustrated in FIGS. 1 and 2, the printing device 1A according to the present embodiment includes a housing 100, and a leg frame 7 is attached to parts near both ends of the housing 100 in the X-axis direction. Although details will be described later, the housing 100 is provided with an operation unit 110 and a maintenance cover 120, as illustrated in FIG. 2.

A caster 13 and an adjuster 14 are provided below the leg frame 7, and the printing device 1A can be easily moved, using the caster 13, and the printing device 1A can be suitably installed on an installation surface G, using the adjuster 14. The printing device 1A according to the present embodiment includes a supply unit 2 that holds the roll body R1 on the −Y direction side, which is the rear side of the housing 100. The supply unit 2 supports a paper tube P of the roll body R1 formed of the wound medium M so as to sandwich the paper tube P in the X-axis direction, and supplies the medium M to a position facing a head 5 as a printing unit.

In the printing device 1A according to the present embodiment, when the medium M is conveyed in a conveyance direction A, the supply unit 2 rotates the roll body R1 in a rotation direction C. Note that, in FIG. 1, the roll body R1 wound such that an image forming surface M1 on which an image is formed is on the outer side is used, but when the roll body R1 wound such that the image forming surface M1 is on the inner side is used, the supply unit 2 rotates the roll body R1 in a direction opposite to the rotation direction C and thus can feed the medium M.

Also, the printing device 1A according to the present embodiment includes a conveyance path of the medium M including a medium support unit 3 that supports the medium M, at a support surface. The printing device 1A according to the present embodiment includes, as the medium support unit 3, an upstream medium support unit 3A, a platen 3B, and a downstream medium support unit 3C from upstream to downstream in the conveyance direction A.

Also, the printing device 1A according to the present embodiment includes a roller pair 8 including a drive roller 8A and a driven roller 8B as a conveyance unit for conveying the medium M in the conveyance direction A through the conveyance path. However, the configuration of the conveyance unit is not particularly limited.

Also, the printing device 1A according to the present embodiment includes the head 5 as a printing unit that is provided with a plurality of nozzles at a position facing the platen 3B and that ejects an ink, which is a liquid, from the nozzles and thus forms an image, and a carriage 4 on which the head 5 is mounted and which can move forward and backward in a width direction B. That is, the width direction B corresponds to the direction in which the carriage 4 scans the medium M. A liquid supply path, not illustrated, including a tube or the like is coupled to the head 5, and an ink is supplied to the head 5 from an ink cartridge installed in a liquid supply device, not illustrated, via the liquid supply path. Note that, in the printing device 1A according to the present embodiment, the conveyance direction A at a position facing the head 5, on the platen 3B, is the +Y direction, and the width direction B, which is the direction of movement of the head 5 (scanning direction of the carriage 4), is a direction along the X-axis direction, and the direction of ink ejection is the −Z direction.

With the configuration as described above, while moving forward and backward in the width direction B, which is a direction intersecting the conveyance direction A, the head 5 can eject an ink from the nozzles, not illustrated, onto the conveyed medium M and can form an image thereon. The printing device 1A according to the present embodiment can form a desired image on the medium M by repeating the conveyance of the medium M in the conveyance direction A by a predetermined amount of conveyance and the ejection of the ink while moving the head 5 in the width direction B in a state where the medium M is stopped. However, the configuration of the head 5 is not particularly limited, and a so-called line head or the like in which nozzles for ejecting an ink are provided over the entire width direction B of the medium M can be used.

Also, in the downstream medium support unit 3C of the medium support unit 3, a heater 20 is provided as a heating unit for heating the medium M from the side of a support surface 31 and thus heating a supported surface M2 on the side opposite to the image forming surface M1 of the medium M. The heater 20 in the present embodiment is configured with an electrically heated wire or the like, but is not limited to such a configuration. Also, not only the downstream medium support unit 3C but also the upstream medium support unit 3A and the platen 3B may be provided with a medium heating unit that heats the supported surface M2 on the side opposite to the image forming surface M1 of the medium M.

A take-up unit 6 that winds up the medium M conveyed in the conveyance direction A into a roll shape to form a roll body R2 is provided downstream of the downstream medium support unit 3C in the conveyance direction A. In the printing device 1A according to the present embodiment, the supply unit 2 and the take-up unit 6 have similar configurations. The medium M conveyed from the supply unit 2 to the take-up unit 6 is conveyed in a state where a predetermined tension is applied by the take-up unit 6 or the like. The take-up unit 6 supports the paper tube P, which is the winding core of the roll body R2, so as to sandwich the paper tube P in the X-axis direction, and rotates the paper tube and thus winds up the medium M into a roll shape. In FIG. 1, the take-up unit 6 rotates the roll body R2 in the rotation direction C and thus winds the medium M such that the image forming surface M1 is on the outer side, but the take-up unit 6 may wind up the medium M such that the image forming surface M1 is on the inner side. In this case, the take-up unit 6 rotates the roll body R2 in the direction opposite to the rotation direction C.

A guide bar 200 is provided between the downstream medium support unit 3C and the take-up unit 6 in the conveyance direction A. The guide bar 200 has an arc-shaped contact surface 201 when viewed from the width direction B. The guide bar 200 guides the conveyance of the medium M as the contact surface 201 comes into contact with the supported surface M2 of the medium M wound up by the take-up unit 6. However, the configuration of the guide bar 200 is not particularly limited, and a configuration without having the guide bar 200 may be employed. Also, the guide bar 200 may be supported so as to be swingable and may be made to function to apply tension to the medium M.

As described above, the printing device 1A according to the present embodiment includes the head 5 that ejects an ink, which is a liquid, onto the medium M, the roller pair 8 as a conveyance unit that conveys the medium M in the conveyance direction, and the carriage 4 that holds the head 5 and can scan the medium M with the head 5 in the scanning direction (width direction B) intersecting the conveyance direction A. Also, the printing device 1A according to the present embodiment includes the platen 3B that supports the medium M at a position where the platen 3B can face the head 5, the housing 100 that accommodates the carriage 4, and the downstream medium support unit 3C as the medium support unit 3 that supports the medium M conveyed from the platen 3B in the conveyance direction A, at the support surface 31.

The downstream medium support unit 3C is provided so as to protrude downstream in the conveyance direction A from the housing 100, and includes the heater 20 as a heating unit that heats the medium from the support surface 31 side. As illustrated in FIG. 2, the printing device 1A according to the present embodiment includes, in the housing 100, the operation unit 110 used by the operator when performing various operations.

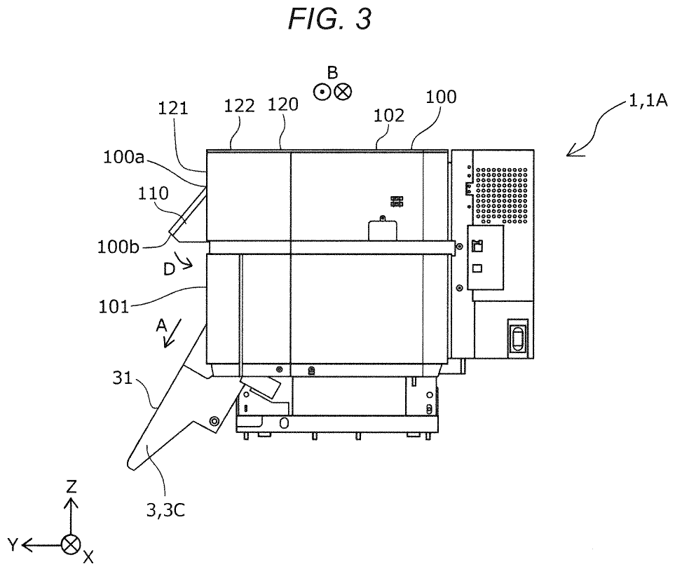

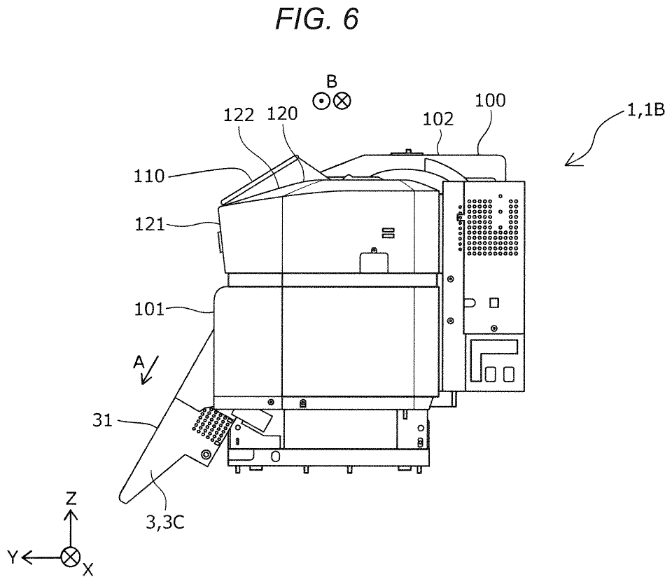

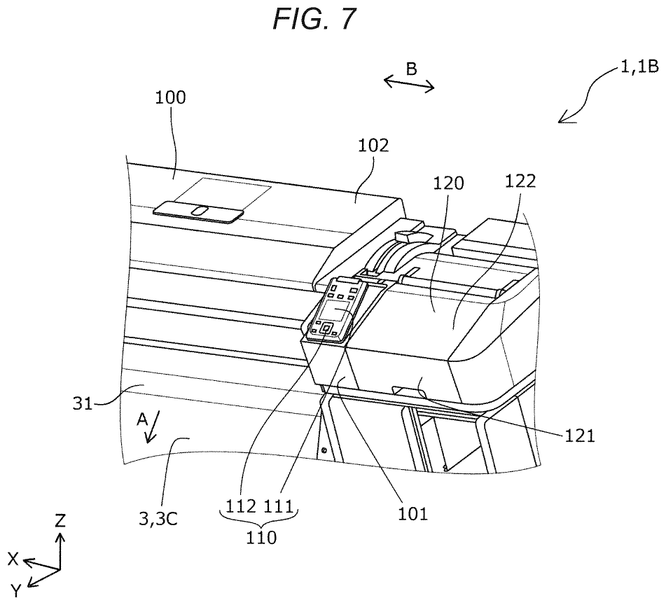

The operation unit 110 will be described in detail below with reference to FIGS. 3 to 7. First, a printing device 1B according to a reference example will be described with reference to FIGS. 6 and 7. The printing device 1B according to the reference example has substantially the same configuration as the printing device 1A according to the present embodiment except for the arrangement of the operation unit 110 and the shape of the housing 100.

As illustrated in FIGS. 6 and 7, in the printing device 1B according to the reference example, the operation unit 110 is provided on an upper surface 102, which is an upper part of the housing 100. In such a configuration, when operating the operation unit 110, the operator needs to approach a downstream side surface 101 of the housing 100, and thus the operator needs to approach the downstream medium support unit 3C heated by the heater 20. When the operator approaches the downstream medium support unit 3C, the operator may come into contact with the downstream medium support unit 3C heated by the heater 20.

Meanwhile, in the printing device 1A according to the present embodiment, the operation unit 110 is provided on the downstream side surface 101 in the conveyance direction A in the housing 100, as illustrated in FIGS. 3 to 5. With such a configuration, when the operator operates the operation unit 110, the operation unit 110 is closer to the operator than the upper surface 102, which is an upper part of the housing 100. Therefore, the operator can be spaced apart from the downstream medium support unit 3C, and the chance of coming into contact with the downstream medium support unit 3C heated by the heater 20 is reduced. Therefore, in a configuration in which the downstream medium support unit 3C having the heater 20 and protruding to the operator side is disposed, the operation unit 110 can be easily operated. The downstream side surface 101 may be any surface facing most downstream in the conveyance direction A, of the plurality of surfaces of the housing 100, and a slight inclination in the up-down direction, the left-right direction, or the like is allowed.

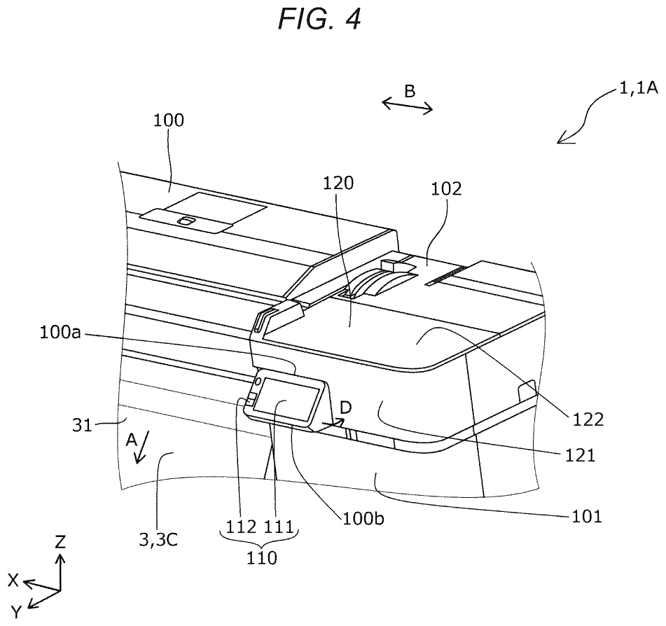

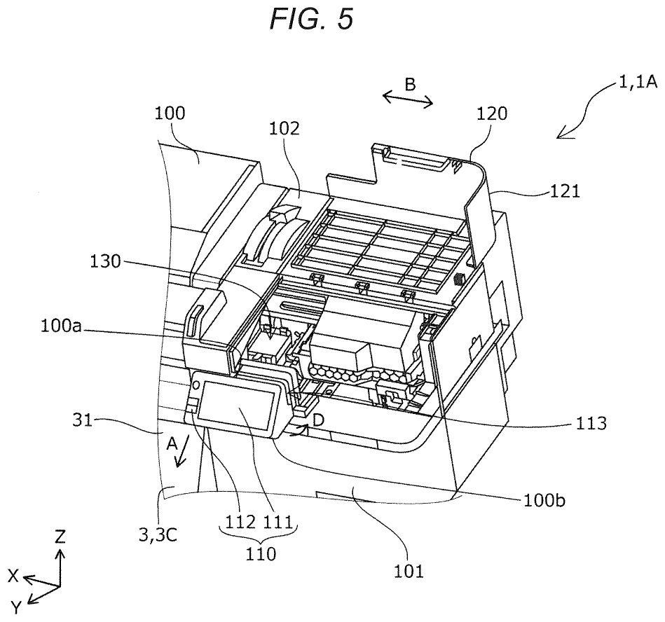

In the printing device 1A according to the present embodiment, the operation unit 110 is provided at an end part on the −X direction side in the X-axis direction corresponding to the width direction B, as illustrated in FIGS. 4 and 5. From another point of view, the operation unit 110 is located on one side in the scanning direction of the carriage 4 in relation to the downstream medium support unit 3C.

For example, when the operator operates the operation unit 110 with the right hand, the body of the operator moves to the left and thus the body tends to approach the downstream medium support unit 3C. Therefore, in general, when the position of the operation unit 110 is more to the right than the downstream medium support unit 3C as viewed from the operation position of the operator, the operation with the right hand tends to be hard to perform, and when the position of the operation unit 110 is more to the left than the downstream medium support unit 3C as viewed from the operation position of the operator, the operation with the left hand tends to be hard to perform.

However, in the printing device 1A according to the present embodiment, since the operation unit 110 is provided downstream in the conveyance direction A, in other words, the operation unit 110 can be operated at a position spaced apart downstream in the conveyance direction A from the downstream medium support unit 3C, for example, even when the operator operates the operation unit 110 with the right hand, which is one hand when the operator faces the printing device 1A straight, the operator can easily operate the operation unit 110 at such a position that the body of the operator is spaced apart from the downstream medium support unit 3C.

As illustrated in FIG. 5, the printing device 1A according to the present embodiment includes a maintenance unit 130 that is provided in an area inside the housing 100 and that can be accessed when the maintenance cover 120 is opened. From another point of view, the printing device 1A according to the present embodiment includes the maintenance unit 130 that can face the head 5 at a position on the −X direction side, which is on one side in relation to the platen 3B in the housing 100. Therefore, the head 5 can continue to be used suitably as maintenance is performed thereon.

The housing 100 can be expressed as having the maintenance cover 120 that can open the upper side of the maintenance unit 130. Since the printing device 1A according to the present embodiment has such a configuration, the upper surface 102 of the housing 100 can be widely opened and workability in cleaning the maintenance unit 130, replacing members, and the like, can be improved. The maintenance unit 130 in the present embodiment includes a wiper that can wipe the nozzle surface of the head 5, a cap that can cover the nozzle surface of the head 5, and a suction unit that can suck the ink from the nozzles of the head 5 via the cap. However, the configuration of the maintenance unit 130 is not particularly limited.

As illustrated in FIG. 4, the upper surface 102 is flat when the maintenance cover 120 is in the closed state. Since the printing device 1A according to the present embodiment has such a configuration, a PC, a document, or the like can be placed on the flat upper surface 102, and the operator can perform work using the PC or check the document or the like while operating the operation unit 110. In the printing device 1B according to the reference example illustrated in FIGS. 6 and 7, the upper surface 102 of the housing 100 is not flat, and this makes it hard to place a PC, a document, or the like on the upper surface 102.

As illustrated in FIGS. 4 and 5, an upper end 100a of the operation unit 110 is located below the upper surface 102 of the housing 100. As illustrated in FIG. 5, the maintenance cover 120 can open the space between the upper end 100a of the operation unit 110 and the upper surface 102 of the housing 100. Since the printing device 1A according to the present embodiment has such a configuration, not only an upper surface 122 of the maintenance cover 120 such as the position of the upper part of the operation unit 110, but also at least a part of a side surface 121 of the maintenance cover 120 can be opened, as illustrated in FIG. 5. Therefore, the printing device 1A according to the present embodiment has a configuration in which the periphery of the maintenance unit 130 can be widely opened, and particularly, workability in maintenance can be improved.

As illustrated in FIGS. 4 and 5, in the printing device 1A according to the present embodiment, the operation unit 110 includes a display unit 111. Since the printing device 1A according to the present embodiment has such a configuration, the operator can perform various operations, using the operation unit 110, while checking information displayed on the display unit 111.

Also, as illustrated in FIGS. 4 and 5, in the printing device 1A according to the present embodiment, the display unit 111 is a touch panel and also serves as an input unit. In the printing device 1A according to the present embodiment, since the display unit 111 is a touch panel, the operator can input various instructions while checking information displayed on the display unit 111 even when the side surface of the housing 100 or the maintenance cover 120 has only a small space.

As illustrated in FIGS. 4 and 5, in the printing device 1A according to the present embodiment, the operation unit 110 includes a button unit 112 that can input various instructions such as power-on and power-off, in addition to the display unit 111. However, when the display unit 111 is a touch panel, the number of buttons of the button unit 112 can be reduced and the area of the display unit 111 can be increased in the same occupied area.

In FIGS. 3 to 5, a lower end 100b of the operation unit 110 protrudes from the downstream side surface 101 in the conveyance direction A of the housing 100 to the +Y direction side, which is downstream side in the conveyance direction A. However, the operation unit 110 is configured to be rotationally movable in a direction of rotational movement D illustrated in FIG. 3 and the like about the upper end 100a as an axis of rotational movement. In other words, the operation unit 110 includes a displacement mechanism 113 that enables a displacement between a state where at least a part of the operation unit 110 protrudes from the housing 100 as illustrated in FIGS. 3 to 5 and a state where the operation unit 110 is rotationally moved in the direction of rotational movement D and at least a part thereof is accommodated in the housing 100.

Since the printing device 1A according to the present embodiment has such a configuration, the operation unit 110 can be accommodated in the housing 100 when the operation unit 110 is not operated. Therefore, in the printing device 1A according to the present embodiment, the operation unit 110 can be prevented from becoming an obstacle during work around the printing device 1A other than the work of operating the operation unit 110.

More specifically, the displacement mechanism 113 is a tilt mechanism. Since the displacement mechanism 113 is a tilt mechanism, the angle of rotational movement in the direction of rotational movement D can be changed, the operator can freely change the posture of the operation unit 110, and the operator can operate the operation unit 110 in a posture that enables the operator to easily operate the operation unit. However, the displacement mechanism 113 may have a configuration other than the tilt mechanism. For example, the operation unit 110 may be configured such that the upper end 100a protrudes from the housing 100 together with the lower end 100b.

The present disclosure is not limited to the embodiment described above and can be realized in various configurations without departing from the intent of the present disclosure. To solve the problems described above partially or entirely, or to achieve the advantages described above partially or entirely, the technical features in the embodiment that correspond to the technical features in the respective aspects described in SUMMARY of the present disclosure can be replaced or combined as appropriate. Also, any of the technical features can be deleted as appropriate unless described as essential in the present specification.

What is claimed is:

1. A printing device comprising:
a head configured to eject a liquid onto a medium;
a conveyance unit configured to convey the medium in a conveyance direction;
a carriage configured to hold the head and be able to scan the medium with the head in a scanning direction intersecting the conveyance direction;
a platen configured to support the medium at a position where the medium can face the head;
a housing configured to accommodate the carriage;
a medium support unit provided so as to protrude downstream in the conveyance direction from the housing and configured to support the medium conveyed in the conveyance direction from the platen, at a support surface; and
an operation unit used for various operations, wherein the medium support unit includes a heating unit configured to heat the medium from the support surface side, and
the operation unit is provided at a side surface downstream in the conveyance direction, of the housing.

2. The printing device according to claim 1, wherein
the operation unit is located on one side in the scanning direction in relation to the medium support unit.

3. The printing device according to claim 2, comprising:
a maintenance unit located on the one side in relation to the platen in the housing and configured to be able to face the head, wherein the housing includes a maintenance cover configured to be able to open an upper side of the maintenance unit.

4. The printing device according to claim 3, wherein an upper surface is flat when the maintenance cover is in a closed state.

5. The printing device according to claim 4, wherein
an upper end of the operation unit is located below the upper surface, and
the maintenance cover can open a space between the upper end and the upper surface.

6. The printing device according to claim 1, wherein the operation unit includes a display unit.

7. The printing device according to claim 6, wherein the display unit also serves as an input unit.

8. The printing device according to claim 1, wherein
the operation unit includes a displacement mechanism configured to enable a displacement between a state where at least a part of the operation unit protrudes from the housing and a state where the operation unit is accommodated in the housing.

9. The printing device according to claim 8, wherein the displacement mechanism is a tilt mechanism.
